(19) United States
(12) Patent Application Publication
(10) Pub. No.: US 2024/0332586 A1
(43) Pub. Date: Oct. 3, 2024

(54) FUEL CELL STACK

(71) Applicant: Honda Motor Co., Ltd., Tokyo (JP)

(72) Inventors: Masaaki Sakano, Saitama (JP); Yuta Oshima, Saitama (JP)

(21) Appl. No.: 18/588,152

(22) Filed: Feb. 27, 2024

(30) Foreign Application Priority Data
Mar. 30, 2023 (JP) 2023-056566

(51) Int. Cl. H01M 8/242; H01M 8/0247; H01M 8/0258; H01M 8/04029; H01M 8/10

(52) U.S. Cl. CPC H01M 8/242; H01M 8/0247; H01M 8/0258; H01M 8/04029; H01M 2008/1095

(57) ABSTRACT

A fuel cell stack including a cell stacked body, a case surrounding the cell stacked body, and a guide member attached to an inner wall of the case to extend in a stacked direction of the cell stacked body and including an engaged portion protruding toward an edge portion of a separator. The separator includes an engagement portion engaging with the engaged portion, the inner wall includes a guide support portion supporting the guide member, and the guide support portion includes a first restriction portion restricting a movement of the guide member in a thickness direction of the inner wall perpendicular to the stacked direction, and a second restriction portion restricting a movement of the guide member in a direction perpendicular to the stacked direction and the thickness direction.

### CROSS-REFERENCE TO RELATED APPLICATION

This application is based upon and claims the benefit of priority from Japanese Patent Application No. 2023-056566 filed on Mar. 30, 2023, the content of which is incorporated herein by reference.

### BACKGROUND OF THE INVENTION

### Field of the Invention

This invention relates to a fuel cell stack configured by stacking a plurality of cells.

### Description of the Related Art

In recent years, technological developments have been made on a fuel cell that contribute to energy efficiency in order to ensure access to energy that is affordable, reliable, sustainable and advanced by more people. Conventionally, as a technology related to a fuel cell stack used in a fuel cell of this type, a fuel cell stack has been known in which a cylindrical positioning pin is erected from an end plate on one end side, and power generation cells having separators are stacked while positioning by the positioning pin. Such a fuel cell stack is described, for example, in Japanese Patent Publication No. 7174789 (JP 7174789 B). In the fuel cell stack described in JP 7174789 B, the power generation cells are positioned by welding support portions to the edge portions of the plurality of separators, and inserting the positioning pins into the through-holes provided in the support portions.

However, in the fuel cell stack described in JP 7174789 B, when an impact is applied from the outside, a stacked body of the power generation cells may collide with a case, and the stacked body may be damaged.

### SUMMARY OF THE INVENTION

An aspect of the present invention is a fuel cell stack including a cell stacked body configured to stack alternately a unitized electrode assembly having an electrolyte membrane and an electrode and a separator, a case surrounding the cell stacked body, and a guide member attached to an inner wall of the case to extend in a stacked direction of the cell stacked body and including an engaged portion protruding toward an edge portion of the separator. The separator includes an engagement portion engaging with the engaged portion of the guide member, the inner wall includes a guide support portion supporting the guide member, the stacked direction is a first direction, a thickness direction of the inner wall perpendicular to the stacked direction is a second direction, and a direction perpendicular to the first direction and the second direction is a third direction, and the guide support portion includes a first restriction portion restricting a movement of the guide member in the second direction and a second restriction portion restricting a movement of the guide member in the third direction.

### BRIEF DESCRIPTION OF THE DRAWINGS

The objects, features, and advantages of the present invention will become clearer from the following description of embodiments in relation to the attached drawings, in which:

FIG. 1 is an exploded perspective view schematically showing an overall configuration of a fuel cell stack according to an embodiment of the present invention;

FIG. 2 is a perspective view showing schematically a configuration of a main part of the fuel cell stack in FIG. 1;

FIG. 3 is a perspective view illustrating schematically a configuration a unitized electrode assembly included in the fuel cell stack in FIG. 2;

FIG. 4 is a plan view showing an arrangement of the separator in the case;

FIG. 5 is an enlarged view of V part in FIG. 4;

FIG. 6 is a perspective view illustrating an engaged state of a guide member included in the fuel cell stack in FIG. 1;

FIG. 7 is a positional relationship of the guide member with respect to an engagement groove and a recess;

FIG. 8 is a perspective view illustrating a state of attaching an extension guide member to an upper end portion of the guide member;

FIG. 9A is a view of an upper end surface of the guide member in FIG. 8 from above;

FIG. 9B is a view of a lower end surface of the extension guide member in FIG. 8;

FIG. 10 is a view illustrating other examples of the upper end surface of the guide member and the lower end surface of the extension guide member in a table form;

FIG. 11A is a view illustrating an example of an assembly procedure of an assembly method of a fuel cell stack according to the embodiment of the present invention;

FIG. 11B is a view illustrating an example of the assembly procedure following FIG. 11A;

FIG. 11C is a view illustrating an example of the assembly procedure following FIG. 11B;

FIG. 11D is a view illustrating an example of the assembly procedure following FIG. 11C;

FIG. 11E is a view illustrating an example of the assembly procedure following FIG. 11D;

FIG. 12 is a view illustrating an example of the assembly procedure following FIG. 11E;

FIG. 13 is a view illustrating a modification of the extension guide member in FIG. 8.

### DETAILED DESCRIPTION OF THE INVENTION

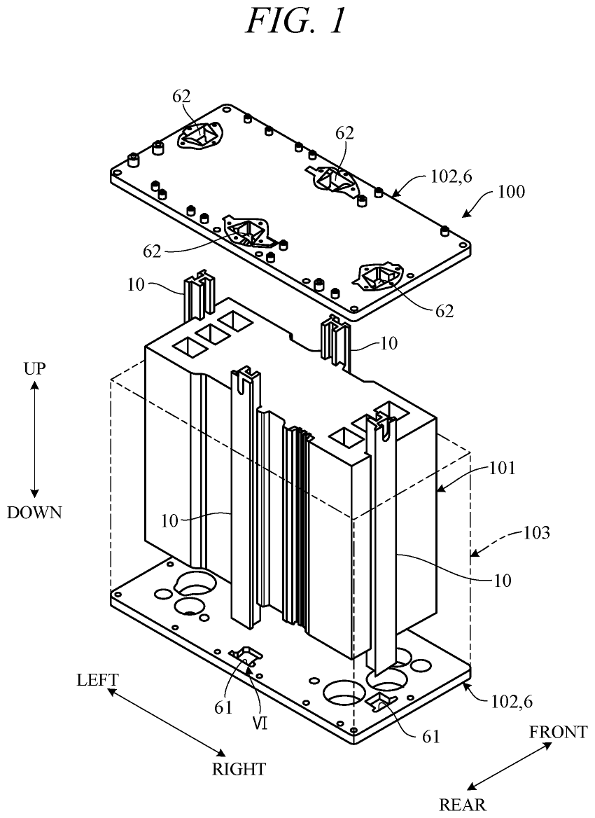

Hereinafter, an embodiment of the present invention will be described with reference to FIGS. 1 to 13. A fuel cell stack according to an embodiment of the present invention is a main component of a fuel cell. The fuel cell is mounted on, for example, a vehicle and can generate electric power for driving the vehicle. The fuel cell can be mounted on various industrial machines in addition to a moving body other than a vehicle such as an aircraft or a boat, a robot, and the like.

First, an overall configuration of the fuel cell stack will be schematically described. FIG. 1 is an exploded perspective view schematically showing an overall configuration of a fuel cell stack 100 according to the embodiment of the present invention, and a view showing a state in the middle of assembling the fuel cell stack 100. Hereinafter, for the sake of convenience, three-axis directions orthogonal to each other as illustrated in the drawing are defined as a front-rear direction, a left-right direction, and an up-down direction, and a configuration of each unit will be described according to such definitions. The up-down direction is a stacked direction of the fuel cell stack 100 when assembling the fuel cell stack 100, and the down direction corresponds to a gravity direction. The fuel cell stack 100 which has been assembled is laid down and mounted on a vehicle, for example.

As illustrated in FIG. 1, the fuel cell stack 100 includes a cell stacked body 101 formed by stacking a plurality of power generation cells 1 in the front-rear direction, a pair of end units 102 disposed at the up and down ends of the cell stacked body 101, and a case 103 surrounding the cell stacked body 101 having a substantially box shape, and has a substantially rectangular parallelepiped shape as a whole. In FIG. 1, only outlines of the case 103 are shown in two dotted lines without showing the case 103 in detail.

The case 30 has four side walls (front, rear, right and left side walls) 300 opposed to the front face, rear face, right face and left face of the cell stacked body 101, each of which has a substantially rectangular shape. The case 103 is configured in a substantially box shape with the up face and the down face opened by these four side walls. The up face and the down face of the case 103 are covered by the end units 102. The case 103 is made of a metal such as aluminum or iron. A guide member 10 extending in the up-down direction is interposed between the cell stacked body 101 and the side wall of the case 103.

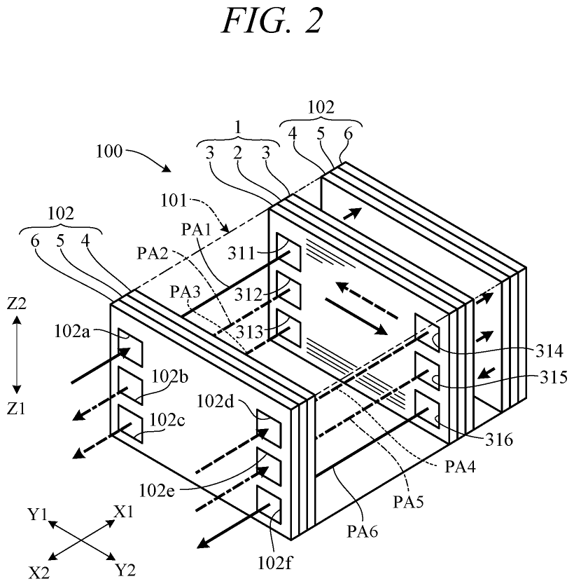

FIG. 2 is a perspective view showing schematically a configuration of a main part of the fuel cell stack 100, and corresponds to a state where the fuel cell stack 100 is mounted on the vehicle. In FIG. 2, three-axis directions orthogonal to each other are shown as X1-X2 direction, Y1-Y2 direction, and Z1-Z2 direction. The stacked direction of the fuel cell stack 100 (up-down direction in FIG. 1) corresponds to the X1-X2 direction. In FIG. 2, the case 103 and the guide member 10 are omitted. Therefore, a detailed configuration at a peripheral portion of the cell stacked body 101 are not shown.

The cell stacked body 101 is formed by stacking a plurality of the power generation cells 1. In FIG. 2, a single power generation cell 1 is shown for the sake of convenience. The power generation cell 1 includes a unitized electrode assembly (UEA) 2 having a membrane electrode assembly including an electrolyte membrane and an electrode, and separators 3 and 3 that are disposed on both sides in the X1-X2 direction of the unitized electrode assembly 2 and sandwich the unitized electrode assembly 2. The unitized electrode assembly 2 and the separator 3 are alternately disposed in the X1-X2 direction. The unitized electrode assembly 2 may be called a membrane electrode structural body.

The separator 3 includes a pair of metal thin plates having a corrugated cross section, and is integrally formed by joining outer peripheral edges of the thin plates. For the separator 3, a conductive material having excellent corrosion resistance is used, and for example, titanium, a titanium alloy, stainless steel, or the like can be used. The pair of thin plates 31 and 32 are formed in an uneven shape by press-molding or the like so that a cooling flow path through which a cooling medium flows is formed inside the separator 3 (between the pair of thin plates), and a power generation surface of the power generation cell 1 is cooled by the flow of the cooling medium. For example, water can be used as the cooling medium. Surfaces of the separators 3 facing the unitized electrode assembly 2 are formed in an uneven shape to form gas flow paths between the separators and the membrane electrode assembly of the unitized electrode assembly 2, i.e., power generation surface.

The separator 3 on the X1 direction side of the unitized electrode assembly 2 is, for example, a separator on an anode side (anode separator), and an anode flow path through which a fuel gas flows is formed between the anode separator 3 and the membrane electrode assembly of the unitized electrode assembly 2. The separator 3 on the X2-direction side of the unitized electrode assembly 2 is, for example, a separator on a cathode side (cathode separator), and a cathode flow path through which an oxidant gas flows is formed between the cathode separator 3 and the membrane electrode assembly of the unitized electrode assembly 2. For example, a hydrogen gas can be used as the fuel gas, and for example, air can be used as the oxidant gas. The fuel gas and the oxidant gas may be referred to as a reaction gas without being distinguished from each other.

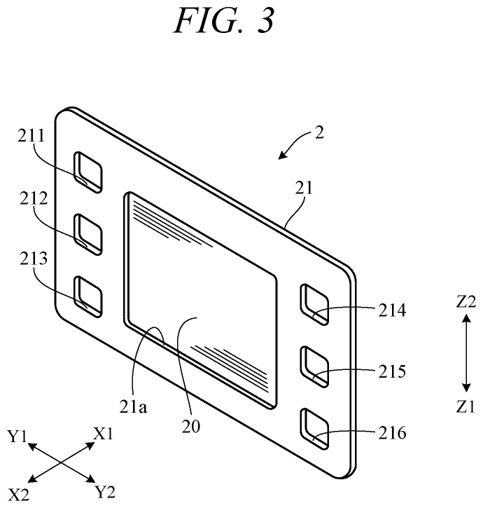

FIG. 3 is a perspective view illustrating a schematic configuration of the unitized electrode assembly 2. As illustrated in FIG. 3, the unitized electrode assembly 2 includes a substantially rectangular membrane electrode assembly (MEA) 20 and a frame 21 that supports the membrane electrode assembly 20. The membrane electrode assembly 20 has an electrolyte membrane, an anode electrode provided on a surface on the X1 direction side of the electrolyte membrane, and a cathode electrode provided on a surface on the X2-direction side of the electrolyte membrane.

The electrolyte membrane is, for example, a solid polymer electrolyte membrane, and a thin film of perfluorosulfonic acid containing moisture can be used. Not only a fluorine-based electrolyte but also a hydrocarbon-based electrolyte can be used.

The anode electrode has an electrode catalyst layer formed on a surface on the X1 direction side of the electrolyte membrane and served as a reaction field of electrode reaction, and a gas diffusion layer formed on a surface on the X1 direction side of the electrode catalyst layer to spread and supply the reaction gas. The cathode electrode has an electrode catalyst layer formed on a surface on the X2 direction side of the electrolyte membrane and served as a reaction field of electrode reaction, and a gas diffusion layer formed on a surface on the X2 direction side of the electrode catalyst layer to spread and supply the reaction gas. The electrode catalyst layer includes a catalytic metal that promotes an electrochemical reaction between hydrogen contained in the fuel gas and oxygen contained in the oxidant gas, an electrolyte having proton conductivity, carbon particles having electron conductivity, and the like. The gas diffusion layer is made of a conductive member having gas permeability, for example, a carbon porous body.

In the anode electrode, the fuel gas (hydrogen) supplied through the anode flow path and the gas diffusion layer is ionized by an action of a catalyst, passes through the electrolyte membrane, and moves to the cathode electrode side. Electrons generated at this time pass through an external circuit and are extracted as electric energy. In the cathode electrode, an oxidant gas (oxygen) supplied via the cathode flow path and the gas diffusion layer reacts with hydrogen ions guided from the anode electrode and electrons moved from the anode electrode to generate water. The generated water gives an appropriate humidity to the electrolyte membrane, and excess water is discharged to an outside of the unitized electrode assembly 2.

The frame 21 is a thin plate having a substantially rectangular shape, and is made of an insulating resin, rubber, or the like. A substantially rectangular opening 21a is provided in a central portion of the frame 21. The membrane electrode assembly 20 is disposed to cover the entire opening 21a and a peripheral portion of the membrane electrode assembly 20 is supported by the frame 21. Three through-holes 211 to 213 penetrating the frame 21 in the X1-X2 direction are opened side by side in the Z1-Z2 direction on a Y1 direction side of the opening 21a of the frame 21, and three through-holes 214 to 216 penetrating the frame 21 in the X1-X2 direction are opened side by side in the Z1-Z2 direction on a Y2 direction side of the opening 21a.

As shown in FIG. 2, through-holes 311 to 316 penetrating the separators 3 in the X1-X2 direction are opened in the separators 3 at positions corresponding to the through-holes 211 to 216 of the frame 21. The through-holes 311 to 316 communicate with the through-holes 211 to 216 of the frame 21. The set of the through-holes 211 to 216 and 311 to 316 communicating with each other forms flow paths PA1 to PA6 (indicated by arrows for the sake of convenience) penetrating the cell stacked body 101 and extending in the X1-X2 direction. The flow paths PA1 to PA6 may be referred to as manifolds. The flow paths PA1 to PA6 are connected to a manifold outside the fuel cell stack 100.

The flow path PA1 (solid arrow) extending toward the X1 direction via the through-holes 211 and 311 is a fuel gas supply flow path. The flow path PA6 (solid arrow) extending toward the X2 direction via the through-holes 216 and 316 is a fuel gas discharge flow path. The fuel gas supply flow path PA1 and the fuel gas discharge flow path PA6 communicate with the anode flow path facing the surface on the X1 direction side of the membrane electrode assembly 20, and as indicated by the solid arrows, the fuel gas flows through the anode flow path in the Y1-Y2 direction via the fuel gas supply flow path PA1 and the fuel gas discharge flow path PA6. The communication between the anode flow path and the other flow paths PA2 to PA5 is blocked via seal portions not shown.

The flow path PA4 (dotted arrow) extending toward the X1-direction via the through-holes 214 and 314 is an oxidant gas supply flow path. The flow path PA3 (dotted arrow) extending toward the X2 direction via the through-holes 213 and 313 is an oxidant gas discharge flow path. The oxidant gas supply flow path PA4 and the oxidant gas discharge flow path PA3 communicate with the cathode flow path facing a surface on the X2 direction side of the membrane electrode assembly 20, and as indicated by the dotted arrows, the oxidant gas flows through the cathode flow path in the Y-Y2 direction via the oxidant gas supply flow path PA4 and the oxidant gas discharge flow path PA3. The communication between the cathode flow path and the other flow paths PA1, PA2, PA5 and PA6 is blocked via seal portions not shown.

The flow path PA5 (dashed-dotted line arrow) extending toward the X1 direction via the through-holes 215 and 315 is a cooling medium supply flow path. The flow path PA2 (dashed-dotted line arrow) extending toward the X2 direction via the through-holes 212 and 312 is a cooling medium discharge flow path. The cooling medium supply flow path PA5 and the cooling medium discharge flow path PA2 communicate with the cooling flow path inside the separator 3, and the cooling medium flows through the cooling flow path via the cooling medium supply flow path PA5 and the cooling medium discharge flow path PA2. The communication between the cooling flow path and the other flow paths PA1, PA3, PA4 and PA6 is blocked via seal portions not shown.

As illustrated in FIG. 2, each of the end units 102 disposed on both sides in the stacked direction of the cell stacked body 101 includes a terminal plate 4, an insulating plate 5, and an end plate 6. The end unit 102 on the X1 direction side may be referred to as a dry-side end unit, and the end unit 102 on the X2 direction side may be referred to as a wet-side end unit. The pair of terminal plates 4 and 4 is disposed on both sides of the cell stacked body 101 with the cell stacked body interposed therebetween. The pair of insulating plates 5 and 5 is disposed on both sides of the terminal plates 4 and 4. The pair of end plates 6 and 6 is disposed on both sides of the insulating plates 5 and 5.

The terminal plate 4 is a substantially rectangular plate-shaped member made of metal, and has a terminal portion for extracting electric power generated by an electrochemical reaction in the cell stacked body 101. The insulating plate 5 is a substantially rectangular plate-shaped member made of non-conductive resin or rubber, and electrically insulates the terminal plate 4 from the end plate 6. The end plate 6 is a plate-shaped member made of metal or resin having high strength.

In FIG. 1, a pair of end plates 6 and 6 are shown as the end units 102, and the terminal plates 4 and the insulating plates 5 are not shown. The upper end plate 6 of FIG. 1 is a dry-side end plate and the lower end plate 6 is a wet-side end plate. Both upper and lower end portions of the case 103 are fixed to the pair of end plates 6 and 6 by bolts. More specifically, in a state in which the lower end plate 6 and the case 103 are fixed by bolts, the upper end plate 6 is pushed down from above, and the upper end plate 6 and the case 103 are fixed by bolts. As a result, the fuel cell stack 100 is held in a state of being pressed by the pair of upper and lower end plates 6 and 6.

As illustrated in FIG. 2, a plurality of through-holes 102a to 102f penetrating the wet-side end unit 102 (on the X2 direction side) in the X1-X2 direction are opened in the wet-side end unit 102. The through-holes 102a to 102f include a through-hole penetrating the terminal plate 4, a through-hole penetrating the insulating plate 5, and a through-hole penetrating the end plate 6. In FIG. 1, these through-holes are collectively referred to as through-holes 102a to 102f for the sake of convenience. In the dry-side end unit 102, similar to the wet-side end unit 102, through-holes 102a to 102f penetrating the dry-side end unit 102 (on the X1-direction side) are opened in the terminal plate 4 and the insulating plate 5. However, the trough-holes 102a to 102f are not opened in the end plate 6 of the dry-side end unit 102.

The through-hole 102a communicates with the fuel gas supply flow path PA1. The through-hole 102b communicates with the cooling medium discharge flow path PA2. The through-hole 102c communicates with the oxidant gas discharge flow path PA3. The through-hole 102d communicates with the oxidant gas supply flow path PA4. The through-hole 102e communicates with the cooling medium supply flow path PA5. The through-hole 102f communicates with the fuel gas discharge flow path PA6.

A fuel gas tank storing a high-pressure fuel gas is connected to the through-hole 102a, and the fuel gas in the fuel gas tank is supplied to the fuel cell stack 100 via the through-hole 102a. The fuel gas which has passed through the fuel gas discharge flow path PA6 is discharged through the through-hole 102f. A compressor for supplying the oxidant gas is connected to the through-hole 102d, and the oxidant gas compressed by the compressor is supplied to fuel cell stack 100 via the through-hole 102d. The oxidant gas which has passed through the oxidant gas discharge flow path is discharged through the through-hole 102c. A pump for supplying the cooling medium is connected to the through-hole 102e, and the cooling medium is supplied to the fuel cell stack 100 via the through-hole 102e. The cooling medium which has passed through the cooling medium discharge flow path PA2 is discharged through the through-hole 102b.

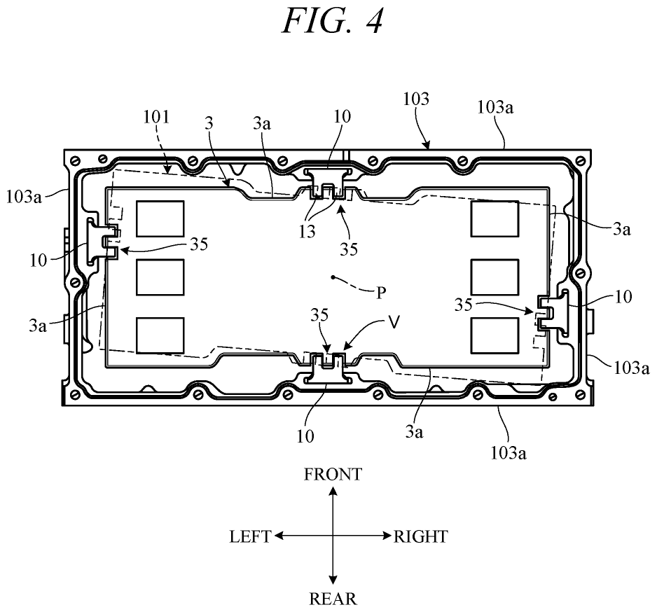

The positions and shapes of the through-holes 211 to 216, 311 to 316, and 102a to 102f illustrated in FIGS. 2 and 3 are merely schematically illustrated in order to describe the flow of the reaction gas and the cooling medium. Some of the through-holes through which the reaction gas and the cooling medium flow are also illustrated in FIG. 1 and FIG. 4 described later, but these through-holes are also only schematically illustrated.

A fuel cell stack 100 according to the present embodiment has a positioning structure of a cell stacked body 101. This point will be described below. FIG. 4 is a plan view (a view of the cell stacked body 101 of FIG. 1 as viewed from above) illustrating the arrangement of a separator 3 in a case 103. As illustrated in FIG. 4, the case 103 has front, rear, left, and right side walls 103a. End portions of the side walls 103a are joined to each other, and the case 103 is entirely configured in a frame shape so as to form a shape with a substantially rectangular parallelepiped shape therein. Hereinafter, a direction toward a center P in the front-rear and left-right directions of the case 103 is referred to as a case inner side, and a direction away from the center P is referred to as a case outer side.

Engagement portions 35 are respectively provided at front, rear, left, and right edge portions 3a of the separator 3. The engagement portion 35 is provided, for example, at an intermediate portion in the left-right direction or an intermediate portion in the front-rear direction of the edge portion 3a of the separator 3. In the left and right edge portions 3a of the separator 3 in FIG. 4, the engagement portions 35 are provided at positions shifted from the intermediate portion in the front-rear direction in consideration of the positions of the through-holes provided at the left and right end portions of the separator 3. A guide member 10 is engaged with the engagement portion 35, and the separator 3 is supported from the side wall 103a of the case 103 via the guide member 10. On the other hand, during the assembly of the fuel cell stack 100, a single unitized electrode assembly 2 is joined in advance to a single separator 3 by welding, bonding, or the like to form a set of unit cell, and a plurality of sets of unit cells are sequentially stacked in the case 103. Therefore, the engagement portion is not provided at the edge portion of a frame 21 (FIG. 3) of the unitized electrode assembly 2, and an outer edge portion of the frame 21 is positioned on the case inner side of the engagement portion 35.

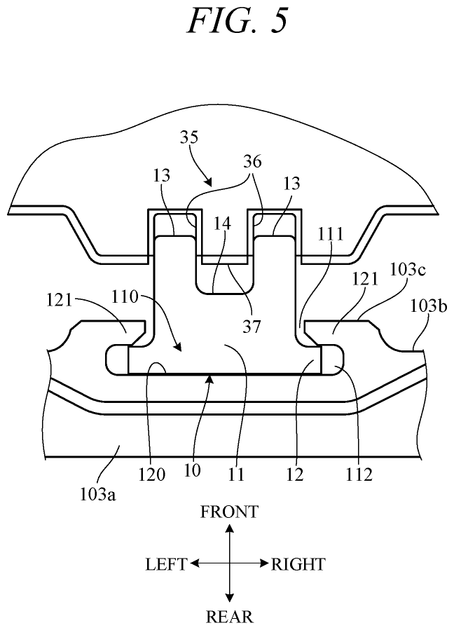

FIG. 5 is an enlarged view of a main part (enlarged view of a “V” part) in FIG. 4 illustrating a configuration around the guide member 10 (rear guide member 10). The configurations around the guide members 10 at the four positions of the front side, the rear side, the left side, and the right side are equal to each other. The guide member 10 is formed by extrusion molding using resin as a constituent material. Therefore, the cross-sectional shape of the guide member 10 is uniform in a longitudinal direction (up-down direction). As illustrated in FIG. 5, the guide member 10 is engaged with an engagement groove 110 provided in the side wall 103a of the case 103. The engagement groove 110 is provided at a position corresponding to the engagement portion 35 of the separator 3. Therefore, as illustrated in FIG. 4, the engagement grooves 110 are provided at the intermediate portions in the left-right direction of the front and rear side walls 103a, and are provided at the intermediate portions in the front-rear direction of the left and right side walls 103a or at positioned shifted to the corner sides from the intermediate portion in the front-rear direction of the left and right side walls 103a by a predetermined amount.

The engagement groove 110 is configured by a recess 120 provided on an inner surface 103b of the side wall 103a, and extends over the entire length in the up-down direction of the side wall 103a. More specifically, the engagement groove 110 has a width (length in the left-right direction in FIG. 5) and a depth (length in the front-rear direction in FIG. 5) with a predetermined length over the entire length of the side wall 103a. At the inner surface 103b of the side wall 103a, a bulged portion 103c is provided to be bulged from the inner surface 103b to the case inner side. The bulged portion 103c is provided with a pair of protrusion portions 121 and 121 protruding inward in the groove width direction (inward in the left-right direction in FIG. 5). The protrusion portion 121 protrudes toward the case inner side from the inner surface 103b of the side wall 103a.

By providing the protrusion portions 121, the width of the engagement groove 110 on the inlet side (case inner side) is narrower than the width of the engagement groove 110 on the bottom side (case outer side). The inlet side of the engagement groove 110 may be referred to as a groove inlet portion 111, and the bottom side may be referred to as a groove bottom portion 112. The protrusion portion 121 is formed such that the depth (length in the front-rear direction in FIG. 5) of the groove bottom portion 112 is deeper than the depth of the groove inlet portion 111. The groove bottom portion 112 and the groove inlet portion 111 may have the same depth.

The guide member 10 mainly includes three parts in plan view along the depth direction of the engagement groove 110. That is, the guide member 10 includes a base portion 11, a wide portion 12, and an engagement projection portion 13. The base portion 11 is disposed in the groove inlet portion 111 and has a substantially rectangular shape in plan view. The base portion 11 is disposed with a predetermined gap from the distal ends of the pair of protrusion portions 121 and 121 in the groove width direction (the left-right direction in FIG. 5).

The wide portion 12 is disposed on the groove bottom portion 112. The wide portion 12 is formed to be larger than the base portion 11 in the groove width direction, and the length of the wide portion 12 in the groove width direction is longer than the length of the groove inlet portion 111. Therefore, due to the engagement between the wide portion 12 and the engagement groove 110, the movement of the guide member 10 in a groove depth direction (the front-rear direction in FIG. 5) is restricted. In addition, by arranging the protrusion portions 121 to face the base portion 11, the movement of the guide member 10 in the groove width direction is restricted.

The engagement projection portion 13 projects from the end portion of the base portion 11 to the case inner side (the front side in FIG. 5). A pair of engagement projection portions 13 and 13 in the groove width direction project from the base portion 11, and a recess 14 is provided between the pair of engagement projection portions 13 and 13. The entire engagement projection portion 13 is formed in a substantially rectangular shape in plan view.

The engagement portion 35 of the separator 3 has a pair of engagement recesses 36 and 36 in the groove width direction having a substantially rectangular shape in plan view corresponding to the engagement projection portions 13. Further, a projection portion 37 is provided between the pair of engagement recesses 36 and 36 corresponding to the recess 14. The length of the engagement recess 36 in the groove width direction is substantially equal to the length of the engagement projection portion 13 in the groove width direction. In a case where the separator 3 is stacked, the pair of engagement recesses 36 and 36 is fitted into the pair of engagement projection portions 13 and 13 from above, and the projection portion 37 is fitted into the recess 14. Thus, the separator 3 can be stacked while being positioned with respect to the case 103 via the guide member 10.

As illustrated in FIG. 1, on an upper surface of an end plate 6 on the lower side (wet side), a recess 61 is provided corresponding to the position of the guide member 10. The recess 61 is a bottomed recess having a predetermined depth and is not a through-hole. The recess 61 has an inner peripheral surface shape corresponding to the outline of the outer peripheral surface of the guide member 10, and the lower end portion of the guide member 10 is fitted into the recess 61.

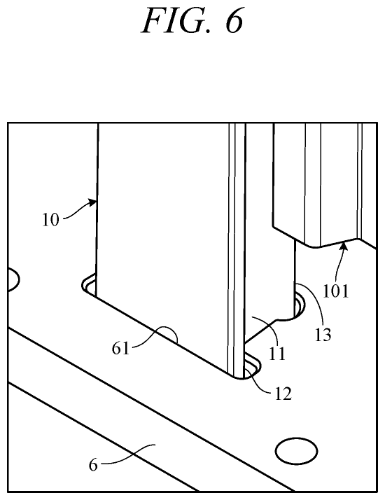

FIG. 6 is a perspective view illustrating a state in which the guide member 10 is fitted into the recess 61 (VI part in FIG. 1). As illustrated in FIG. 6, the guide member 10 is fitted over a predetermined depth until the lower end surface of the guide member 10 abuts on the bottom surface of the recess 61. As illustrated in FIG. 1, the end plate 6 on the upper side (dry side) is provided with through-holes 62 corresponding to the position and shape of the guide members 10, that is, through-holes 62 having the same shape as the inner peripheral surface shape of the recess 61. The upper end portion of the guide member 10 can be inserted into the end plate 6 on the upper side through the through-hole 62. However, in a state where the assembly of the fuel cell stack 100 is completed, as described later, the upper end portion of guide member 10 is fitted into the through-hole 62 without protruding from the upper surface of the end plate 6. As a result, upper and lower end portions of the guide member 10 can be held in a state of being positioned by the upper and lower end plates 6.

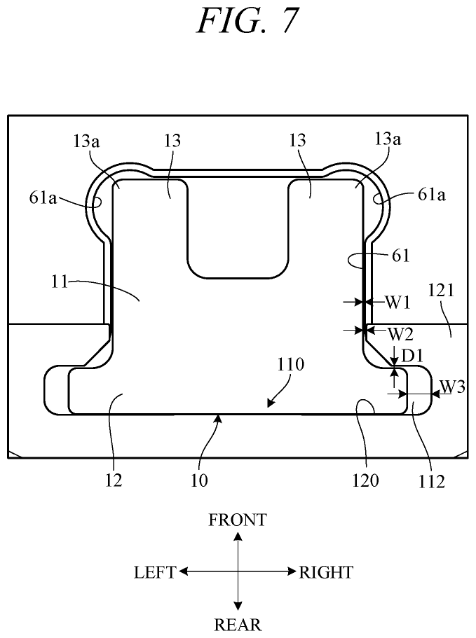

As described above, the guide member 10 is engaged with the recess 120 of the side wall 103a of the case 103, and the lower end portion of the guide member 10 is fitted into the recess 61. FIG. 7 is a plan view illustrating a positional relationship of the guide member 10 with respect to the engagement groove 110 and the recess 61. As illustrated in FIG. 7, the recess 61 is formed in an arc shape such that a corner facing a corner 13a of the engagement projection portion 13 of the guide member 10 is separated from the corner 13a. That is, an arc portion 61a is provided at the corner of the recess 61.

As illustrated in FIG. 7, in a case where a distance between the end surface of the base portion 11 of the guide member 10 and the end surface of the recess 61 that face each other in the groove width direction (the left-right direction in FIG. 7) is defined as W1 and a distance between the end surface of the base portion 11 and the end surface of the protrusion portion 121 that face each other in the groove width direction is defined as W2, the recess 61, the guide member 10, and the protrusion portion 121 are formed such that W1 is smaller than W2. As an example, W1 is 0.1 to 0.2 mm, and W2 is about 3 times the value of W1. As a result, the guide member 10 can be accurately positioned with respect to the end plate 6. In addition, since W2>W1, the guide member 10 can be easily engaged with the engagement groove 110 without interfering with the protrusion portion 121.

Further, in a case where a distance between the end surface of the wide portion 12 of the guide member 10 and the end surface of the recess 120 that face each other in the groove width direction is defined as W3, W3 is larger than W2. In addition, in a case where a distance between the end surface of the wide portion 12 and the end surface of the protrusion portion 121 that face each other in the groove depth direction is defined as D1, D1 is the same value of W2 or a value similar to W2. As a result, the wide portion 12 can be easily fitted into the engagement groove 110 while the guide member 10 is positioned by the protrusion portion 121.

Both the length W2 of the gap between the guide member 10 and the protrusion portion 121 in the groove width direction and the length D1 of the gap between the guide member 10 and the protrusion portion 121 in the groove depth direction are minute (for example, about 0.4 to 0.55 mm). As a result, displacement of the guide member 10 can be restricted, and in a case where an impact is applied to a vehicle, it is possible to suppress collision of the cell stacked body 101 with the side wall 103a of the case 103. That is, when an impact is applied to the vehicle, the cell stacked body 101 relatively moves with respect to the case 103 while rotating in the case, for example, as indicated by a two-dot chain line in FIG. 4 by the inertial force. For this reason, the corner of the cell stacked body 101 may collide with the side wall 103a, and as a result, the cell stacked body 101 may be damaged.

In this regard, in the present embodiment, since the guide member 10 is engaged with the engagement groove 110 so as to be surrounded and held by the protrusion portions 121, it is possible to suppress the displacement of the guide member 10 when an impact is applied to the vehicle. As a result, the relative movement of the cell stacked body 101 can be suppressed, and the cell stacked body 101 can be protected. In particular, as illustrated in FIG. 4, the four guide members 10 are attached to the inner surface of the case 103 such that the engagement projection portions 13 are directed in directions different from each other, and four sides around the cell stacked body 101 are supported via the guide members 10, so that the displacement and rotation of the cell stacked body 101 in the case 103 can be favorably suppressed.

In addition, in the present embodiment, the engagement portion 35 for engaging with the guide member 10 is provided at the edge portion of the separator 3, but the engagement portion 35 has a simple uneven shape (engagement recess 36). Therefore, when the separator 3 is molded by press working, the engagement portion 35 can be simultaneously processed. Thus, it is not necessary to separately weld a positioning tab or the like to the edge portion of the separator 3, and the fuel cell stack 100 can be configured at low cost.

An assembly method of the fuel cell stack 100 configured as described above will be described. The fuel cell stack is assembled by stacking a plurality of power generation cells 1 and then applying a pressurizing force to a stack body from the end plate 6 on the upper side. However, before the pressurizing force is applied, the height of the stack body is higher than the length of the guide member 10. Therefore, the guide member 10 needs to be configured to be extendable. In consideration of this point, in the present embodiment, the guide member 10 is configured as follows such that an extension guide member can be detachably attached to the upper end portion of the guide member 10.

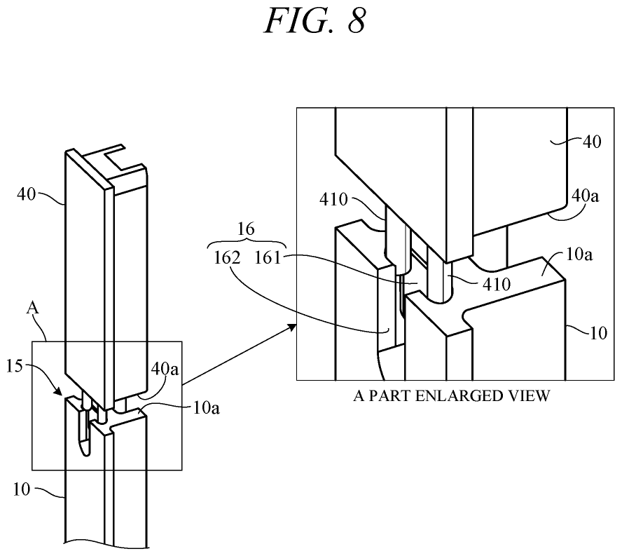

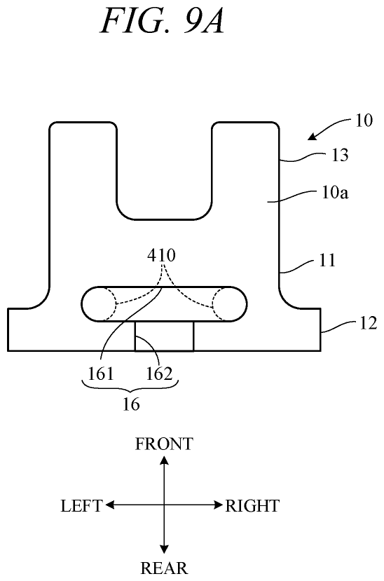

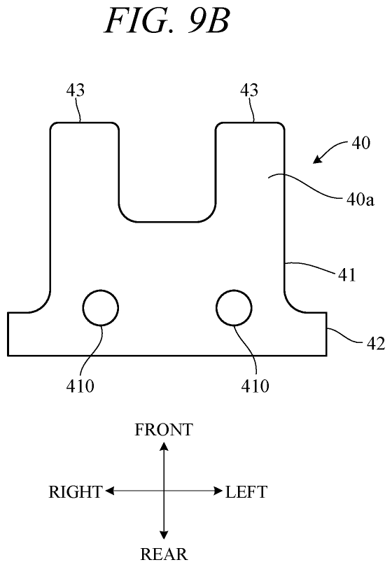

FIG. 8 is a perspective view illustrating a state in the middle of attaching an extension guide member 40 to the upper end portion of the guide member 10. As illustrated in FIG. 8, an upper end surface 10a of the guide member 10 is provided with an extension support portion 15 that supports the extension guide member 40 in an insertable and detachable manner. FIG. 9A is a view of the upper end surface 10a of the guide member 10 as viewed from above, and FIG. 9B is a view of a lower end surface 40a of the extension guide member 40 as viewed from below. In FIGS. 9A and 9B, for convenience, the front-rear direction and the left-right direction are defined in accordance with FIG. 5. FIG. 9B is a view as viewed from below, and thus the left-right direction is opposite to that of FIG. 9A.

As illustrated in FIG. 9B, the outline of the extension guide member 40 is the same as the outline of the guide member 10. Therefore, similarly to the guide member 10, the extension guide member 40 includes a base portion 41, a wide portion 42, and an engagement projection portion 43. The extension guide member 40 is a jig for assembling the fuel cell stack 100, and can be made of metal.

As illustrated in an enlarged view of the “A” part of FIG. 8 and FIG. 9A, the extension support portion 15 is configured by a bottomed recess 16 having a substantially T-shape in plan view and having a predetermined depth provided on the upper end surface 10a of the guide member 10. The bottomed recess 16 includes a lateral recess 161 extending in the left-right direction along a boundary between the base portion 11 and the wide portion 12, and a vertical recess 162 penetrating through the wide portion 12 from the intermediate portion of the lateral recess 161 in the left-right direction and extending rearward. As illustrated in FIG. 9A, both end surfaces of the lateral recess 161 in the left-right direction are formed in a semicircular shape.

As illustrated in an enlarged view of the “A” part of FIG. 8 and FIG. 9B, a pair of left and right pins 410 and 410 having a columnar shape is provided to project downward from the lower end surface 40a of the extension guide member 40. The length of the pin 410 is shorter than the depth of the bottomed recess 16. The diameter of the pin 410 is equal to the width (length in the front-rear direction) of the lateral recess 161. The pins 410 are provided corresponding to the positions of the left and right end portions of the lateral recess 161, and the pins 410 are fitted into the bottomed recess 16 along the semicircular curved surfaces of the left and right ends of the lateral recess 161. The extension guide member 40 is pushed until the lower end surface 40a thereof abuts on the upper end surface of the guide member 10. At this time, the outer peripheral surface indicating the outline of the guide member 10 and the outer peripheral surface indicating the outline of the extension guide member 40 are connected without a step. As a result, the guide member 10 can be extended upward by the amount of the extension guide member 40.

In a state where the extension guide member 40 is attached to the guide member 10 via the pins 410, the pins 410 are housed in the bottomed recess 16 as indicated by dotted lines in FIG. 9A. As a result, the movement and rotation of the extension guide member 40 with respect to the guide member 10 are prevented by the pair of pins 410 and 410, and the relative position of the extension guide member 40 with respect to the guide member 10 can be held at a predetermined position. The extension guide member 40 can be attached to the guide member 10 by pushing the pins 410 downward while fitting the pins 410 into the bottomed recess 16. Further, the extension guide member 40 can be separated from the guide member 10 only by pulling up the extension guide member 40 upward. This facilitates the attachment and detachment, that is, the insertion and detachment of the extension guide member 40.

The configuration of the extension support portion 15 is not limited to the above-described one. Instead of providing the bottomed recess 16 having a predetermined depth on the upper end surface 10a of the guide member 10, for example, a notch having a substantially T-shape that is the same shape as the bottomed recess 16 in plan view may be provided from the upper end surface 10a to the lower end surface of the guide member 10. As a result, since the cross-sectional shape of the guide member 10 is the same over the entire length, the guide member 10 can be easily formed by extrusion molding. Instead of providing the bottomed recess 16, a pair of left and right through-holes corresponding to the shape of the pair of left and right pins 410 and 410 may be provided from the upper end surface 10a to the lower end surface of the guide member 10.

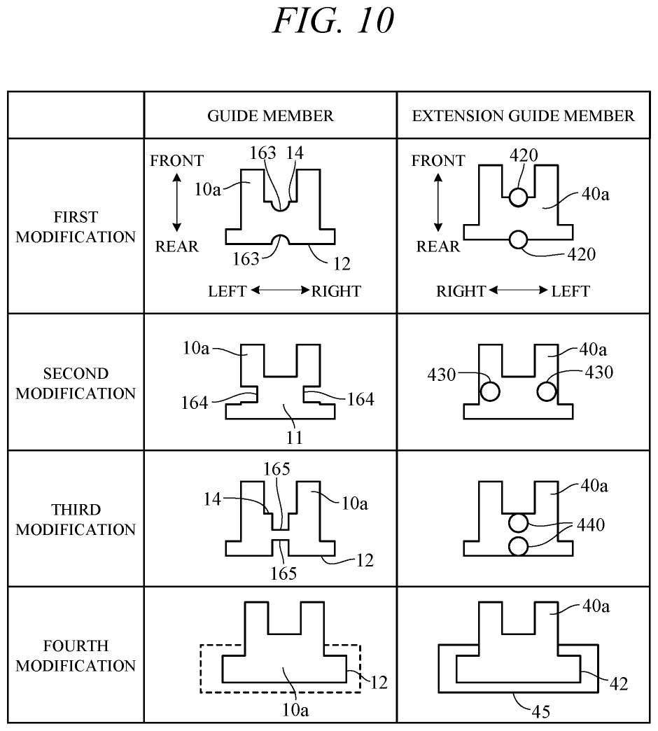

FIG. 10 is a view illustrating other examples (first modification to fourth modification) of the extension support portion 15, and illustrates shapes of the upper end surface 10a of the guide member 10 and the lower end surface 40a of the extension guide member 40 in a table form. In FIG. 10, for convenience, the front-rear and left-right directions are defined as in FIGS. 9A and 9B. As illustrated in FIG. 10, in the first modification, a substantially semicircular notch 163 is provided at the center in the left-right direction of each of the rear surface of the wide portion 12 and the front surface of the recess 14 of the guide member 10. Corresponding to these notches 163, a pair of front and rear pins 420 and 420 is provided to project from the lower end surface 40a of the extension guide member 40, and the pins 420 are fitted to the notches 163.

In the second modification, substantially rectangular notches 164 are provided inward in the left-right direction from the left and right end surfaces of the base portion 11 of the guide member 10. Corresponding to these notches 164, a pair of front and rear pins 430 and 430 is provided to project from the lower end surface 40a of the extension guide member 40, and the pins 430 are fitted to the notches 164. The pins 430 do not protrude outward in the left-right direction from the lower end surface 40a of the extension guide member 40.

In the third modification, a substantially rectangular notch 165 is provided at the center in the left-right direction of each of the rear surface of the wide portion 12 and the front surface of the recess 14 of the guide member 10. Corresponding to these notches 165, a pair of front and rear pins 440 and 440 is provided to project from the lower end surface 40a of the extension guide member 40, and the pins 440 are fitted to the notches 165. The pins 440 do not protrude outward in the front-rear direction from the lower end surface 40a of the extension guide member 40.

In the fourth modification, no recess or notch is provided in the upper end surface 10a of the guide member 10. On the other hand, on the lower end surface 40a of the extension guide member 40, an outer peripheral guide portion 45 is provided to project downward so as to surround the wide portion 42. When the extension guide member 40 is attached, the wide portion 12 of the guide member 10 is surrounded by the outer peripheral guide portion 45 as indicated by a dotted line. At this time, the wide portion 12 of the guide member 10 serves as the extension support portion 15. In the fourth modification, the rear end surface of the extension guide member 40 protrudes rearward from the rear end surface of the guide member 10 by the amount of the outer peripheral guide portion 45. Therefore, the upper end portion of the side wall 103a is configured such that the side wall 103a and the outer peripheral guide portion 45 do not interfere with each other.

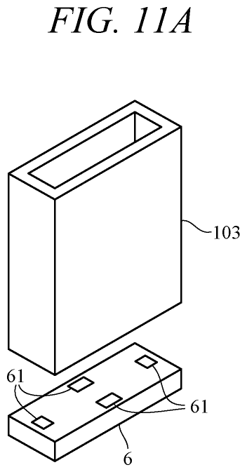

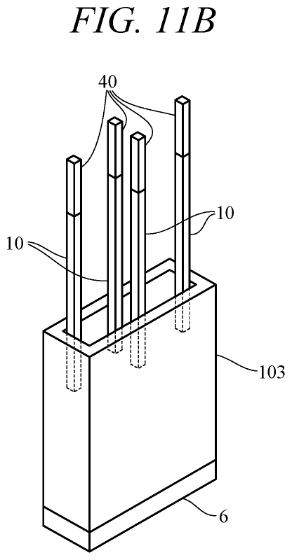

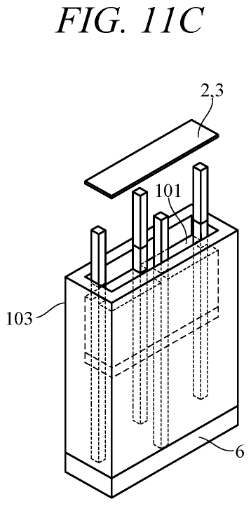

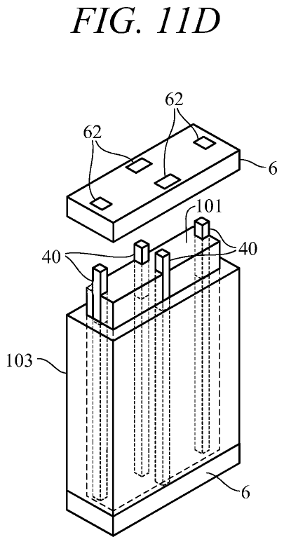

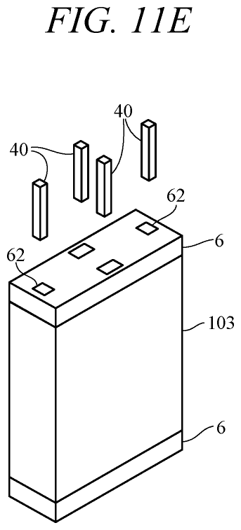

Hereinafter, the assembly method of the fuel cell stack 100 according to the present embodiment will be described. FIGS. 11A to 11E are diagrams illustrating an example of an assembly procedure of the fuel cell stack 100. When the fuel cell stack 100 is assembled, the guide member 10 is manufactured in advance by extrusion molding, and the guide member 10 having a predetermined length is prepared (preparation process). Next, as illustrated in FIG. 11A, the case 103 is fixed to the wet-side end plate 6 using bolts (case attachment process).

Next, as illustrated in FIG. 11B, the guide member 10 is inserted from above the case 103 along the engagement groove 110 (FIG. 5) provided on the inner surface of the side wall 103a of the case 103. Then, the lower end portion of the guide member 10 is fitted into the recess 61 (FIG. 6) on the upper surface of the end plate 6 (guide insertion process). At this time, before or after the fitting of the guide member 10, the extension guide member 40 is attached to the upper end surface 10a of the guide member 10 via the extension support portion 15 (extension guide attachment process). Specifically, the pin 410 projecting from the lower end surface 40a of the extension guide member 40 is fitted into the bottomed recess 16 of the upper end surface 10a of the guide member 10 (FIG. 8), and the extension guide member 40 is held on the extension of the guide member 10 in a state where the upper end surface 10a and the lower end surface 40a abut on each other.

Next, an insulating plate 5 and a terminal plate 4 on the wet side are inserted into the case 103 along the extension guide member 40 and the guide member 10, and sequentially stacked. Next, as illustrated in FIG. 11C, a predetermined number of sets of unit cells, each set of unit cells being obtained such that the single unitized electrode assembly 2 and the single separator 3 are integrally joined in advance, are inserted into the case 103 along the extension guide member 40 and the guide member 10 and sequentially stacked (stacking process). Thus, the cell stacked body 101 is configured. In this case, the unit cells are lowered while the engagement projection portion 43 of the extension guide member 40 and the engagement projection portion 13 of the guide member 10 are engaged with the engagement portions 35 (engagement recesses 36) of the edge portion of the separator 3. Therefore, the cell stacked body 101 can be configured in a state where the unitized electrode assembly 2 and the separator 3 are accurately positioned with reference to the wet-side end plate 6 and the case 103.

Next, the terminal plate 4 and the insulating plate 5 on the dry side are lowered along the extension guide member 40 and sequentially stacked, and then the dry-side end plate 6 is lowered along the extension guide member 40 as illustrated in FIG. 11D. In this case, the end plate 6 is placed above the cell stacked body 101 (strictly, the insulating plate 5) while the extension guide member 40 is inserted into the through-hole 62 of the end plate 6 (stacking final process). Thereafter, a pressurizing force is applied to the cell stacked body 101 from above the end plate 6 using a pressurizer (not illustrated), and the dry-side end plate 6 is fixed to the case 103 using a bolt in a state where the height of the dry-side end plate 6 is maintained at a predetermined height (fixing process). In this state, the extension guide member 40 protrudes upward from the dry-side end plate 6.

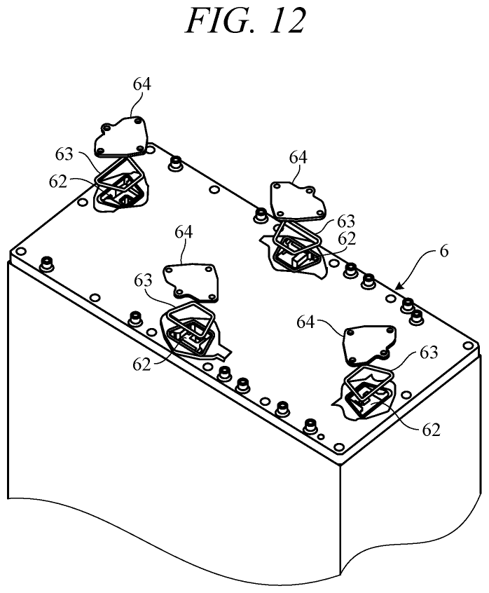

Next, as illustrated in FIG. 11E, the extension guide member 40 is pulled out from the guide member 10 via the through-hole 62 (pulling-out process). Finally, as illustrated in FIG. 12, the through-hole 62 of the end plate 6 is covered with a cover 64 via a sealing material 63 to seal the through-hole 62 (sealing process). The cover 64 is fastened to the end plate 6 using, for example, a bolt. Thus, assembly of the fuel cell stack 100 is completed.

With the above assembly method, the extension guide member 40 can be attached to the guide member 10 by fitting the extension guide member 40 from above the guide member 10. In addition, the extension guide member 40 can be removed from the guide member 10 by pulling out the extension guide member 40 upward. Therefore, the extension guide member 40 as an extension member can be easily attached and detached as compared with a case where the extension member is attached via a screw portion. That is, in a case where the extension member is attached via the screw portion, it is necessary to perform a rotation operation for the extension member, but, in the present embodiment, since the rotation operation is unnecessary for the attachment of the extension guide member 40, the extension guide member 40 can be immediately attached and detached. In addition, in a case where the extension member can be attached via the screw portion, an extra space for rotating the extension member is required around the extension member, but in the present embodiment, such a space is not required, and thus the fuel cell stack 100 can be downsized.

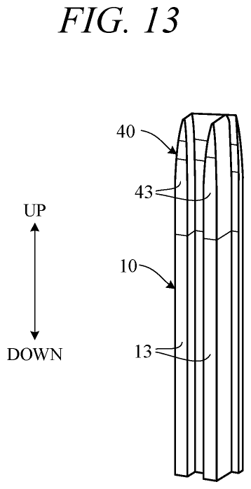

The extension guide member 40 need not have the same cross-sectional shape over the entire length. FIG. 13 is a perspective view illustrating a modification of the extension guide member 40. In the example illustrated in FIG. 13, the extension guide member 40 is configured to be tapered upward. That is, the thickness of the engagement projection portion 43 in the groove width direction gradually decreases as the engagement projection portion 43 is close to the upper side. Accordingly, the engagement portion 35 of the separator 3 can be easily engaged with the extension guide member 40 from above.

According to the present embodiment, the following operations and effects are achievable.
(1) The fuel cell stack 100 includes the cell stacked body 101 in which the unitized electrode assembly 2 including an electrolyte membrane and an electrode and the separator 3 are alternately stacked; the case 103 that surrounds the cell stacked body 101; and the guide member 10 that is attached to the inner surface 103b of the side wall 103a of the case 103, extends in a stacked direction of the cell stacked body 101, and has the engagement projection portion 13 (an engaged portion) protruding toward the edge portion 3a of the separator 3 (FIGS. 1, 2, and 4). The separator 3 has the engagement portion 35 that engages with the engagement projection portion 13 at the distal end portion of the guide member 10 (FIG. 4). The inner surface 103b of the side wall 103a has the recess 120 and the protrusion portion 121 as a guide support portion that support the guide member 10 (FIG. 5). More specifically, the inner surface 103b has a pair of protrusion portions 121 and 121 that restrict the movement of the guide member 10 in the groove depth direction and restrict the movement of the guide member 10 in the groove width direction (FIG. 5).

As a result, the guide member 10 can be firmly held from the inner surface 103b of the case 103 while restricting the displacement and rotation of the guide member 10 with respect to the case 103. Therefore, for example, in a case where an impact is applied from the outside to the vehicle on which the fuel cell stack 100 is mounted, the displacement and rotation of the cell stacked body 101 in the case due to the inertial force are suppressed, and damage to the cell stacked body 101 can be suppressed.
(2) The guide support portion has the recess 120 that forms the engagement groove 110 having a predetermined depth and extending along the stacked direction up to the end surface of the case 103 in the stacked direction, and the protrusion portion 121 that protrudes inward in the width direction of the engagement groove 110 at the groove inlet portion 111 such that the width of the groove inlet portion 111 on the inlet side of the engagement groove 110 is narrower than the width of the groove bottom portion 112 on the bottom side of the engagement groove 110 (FIG. 5). The guide member 10 has the base portion 11 disposed in the groove inlet portion 111, and the wide portion 12 that is disposed in the groove bottom portion 112 and is enlarged in the width direction from the base portion 11 (FIG. 5). As a result, since the guide member 10 is engaged with the engagement groove 110 so as to be surrounded and held by the pair of protrusion portions 121, it is possible to favorably suppress the displacement and rotation of the guide member 10.
(3) The protrusion portion 121 is positioned closer to the case inner side than the inner surface 103b of the case 103. That is, the protrusion portion 121 is provided at the bulged portion 103c bulged from the inner surface 103b of the case 103 toward the edge portion 3a of the separator 3. For this reason, the distance from the corner of the cell stacked body 101 to the inner surface 103b increases, and it is possible to suppress the corner of the cell stacked body 101 from colliding with the inner surface 103b of the case 103 when an impact is applied from the outside.
(4) The length D1 of the gap from the end surface of the wide portion 12 to the end surface of the protrusion portion 121 that face each other in the groove depth direction, and the length W2 of the gap from the end surface of the base portion 11 to the end surface of the protrusion portion 121 that face each other in the groove width direction are shorter than the length W3 of the gap from the end surface of the groove bottom portion 112 to the end surface of the wide portion 12 that face each other in the groove width direction (FIG. 7). As a result, the guide member 10 (particularly, the wide portion 12) can be easily engaged with the engagement groove 110.
(5) The fuel cell stack 100 further includes the end plate 6 having the recess 61 that supports one end portion (lower end portion in FIG. 1) of the guide member 10 in the longitudinal direction (FIG. 1). The guide member 10 has the base portion 11 and the wide portion 12 over the entire length in the longitudinal direction. The recess 61 is configured by the bottomed recess into which the lower end portion of the guide member 10 can be fitted (FIG. 1). The length W1 of the gap from the end surface of the base portion 11 to the end surface of the recess 61 that face each other in the groove width direction is shorter than the length W2 of the gap from the end surface of the base portion 11 to the end surface of the protrusion portion 121 that face each other in the groove width direction (FIG. 7). As a result, the guide member 10 can be accurately positioned with respect to the end plate 6, and the guide member 10 can be easily inserted into the engagement groove 110 over the entire length without interfering with the protrusion portion 121.
(6) The recess 61 of the end plate 6 is formed such that a part facing the corner on a side opposite to the wide portion 12 in the groove depth direction, that is, a part facing the corner of the engagement projection portion 13 has a substantially arc shape (FIG. 7). This facilitates fitting of the guide member 10.
(7) As another viewpoint from the above, the fuel cell stack 100 includes the cell stacked body 101 in which a membrane electrode assembly 20 including an electrolyte membrane and an electrode and the separator 3 are alternately stacked; the wet-side end plate 6 and the dry-side end plate 6 that are respectively disposed on both sides of the cell stacked body 101 in the stacked direction; the case 103 surrounding the cell stacked body 101; and the guide member 10 that is attached to the inner surface 103b of the side wall 103a of the case 103 and extends in the stacked direction (FIGS. 1 and 2). The separator 3 has the engagement portion 35 that engages with the guide member 10 (FIG. 4). The wet-side end plate 6 has the recess 61 that supports one end portion (lower end portion) of the guide member 10 in the longitudinal direction (FIG. 1). The guide member 10 has, at the other end portion (upper end portion) in the longitudinal direction, the extension support portion 15 that supports, in an insertable and detachable manner, the extension guide member 40 extending in the stacked direction continuously to the guide member 10 (FIG. 8).

As a result, since it is not necessary to separately weld the positioning tab or the like to the edge portion of the separator 3, the fuel cell stack 100 can be configured at low cost. That is, the engagement portion 35 to be engaged with the guide member 10 is provided on the edge portion 3a of the separator 3, but the engagement portion 35 can be formed at the same time when the separator 3 is formed by, for example, press working, and thus the cost can be suppressed. In addition, since the extension support portion 15 that supports the extension guide member 40 in an insertable and removable manner is provided at the upper end portion of the guide member 10, the extension guide member 40 can be easily attached to and detached from the upper end portion of the guide member 10, and the fuel cell stack 100 can be easily assembled.
(8) The guide member 10 is made of a resin material having a constant cross-sectional shape over the entire length in the longitudinal direction. Thus, the long guide member 10 can be obtained by extrusion molding. Therefore, as compared with a case of injection molding, the occurrence of warpage, sink marks, and the like is suppressed, and the guide member 10 can be accurately formed. In addition, in a case of changing the number of stacked power generation cells 1 in order to increase or decrease the power generation capacity, it is necessary to change the length of the guide member 10, but the guide member 10 can be formed by extrusion molding, and thus the length of the guide member 10 can be easily changed.
(9) The recess 61 of the end plate 6 is configured by the bottomed recess into which the one end portion of the guide member 10 can be fitted. In a case where the recess 61 is formed by a through-hole, it is necessary to separately provide a seal portion or the like for preventing moisture from entering the case around the recess 61. However, by forming the recess 61 as the bottomed recess, it is not necessary to provide a seal portion, and the configuration can be simplified.
(10) In the wet-side end plate 6, the plurality of supply and discharge through-holes 102a to 102f for supplying the reaction gas and the cooling medium to the cell stacked body 101 and discharging the reaction gas and the cooling medium from the cell stacked body 101 are opened (FIG. 2). On the other hand, in the dry-side end plate 6, such a supply and discharge through-hole is not opened, but the through-hole 62 through which the extension guide member 40 is inserted is opened, and the through-hole 62 is sealed by the cover 64 (FIGS. 1 and 12). In a case where the dry-side end plate 6 is provided with the recess into which the lower end portion of the guide member 10 is fitted and the wet-side end plate 6 is provided with the through-hole through which the extension guide member 40 is inserted, the number of through-holes that need to be sealed in the wet-side end plate 6 increases, and thus the configuration of the wet-side end plate 6 becomes complicated. On the other hand, in the case of the dry-side end plate 6, the through-hole 62 that needs to be sealed can be easily formed.
(11) As another viewpoint from the above, an assembly method of the fuel cell stack 100 includes: a process (guide insertion process) of introducing the guide member 10 along the inner surface 103b of the side wall 103a of the case 103 and fitting one end portion (lower end portion) of the guide member 10 into the recess 61 provided in the end plate 6 disposed at the end portion of the case 103; a process (stacking process) of, in a state where the extension guide member 40 is attached to the other end portion (upper end portion) of the guide member 10 to form an assembly (referred to as guide member assemblies 10 and 40) of the guide member 10 and the extension guide member 40, alternately stacking the membrane electrode assembly 20 including an electrolyte membrane and an electrode and the separator 3 while engaging the engagement portion 35 provided in the separator 3 with the guide member assemblies 10 and 40; a process (stacking final process) of placing the end plate 6 while being guided by the guide member assemblies 10 and 40; a process (fixing process) of shortening the length from the end plate 6 on the lower side to the end plate 6 on the upper side to a predetermined length and fixing the end plate 6 to the case 103 (fixing process); and a process (pulling-out process) of pulling out the extension guide member 40 protruding outward from the end plate 6 on the upper side, from the upper end portion of the guide member 10 (FIGS. 11A to 11E).

With this configuration, the extension guide member 40 can be attached to and detached from the upper end portion of the guide member 10 by inserting or pulling out the extension guide member 40 from above. This facilitates the attachment and detachment of the extension guide member 40. That is, in a case where an extension member such as the extension guide member 40 is attached and detached via a screw portion, an operation of rotating the extension member is required, but in the present embodiment, the rotation operation is not required. Therefore, the attachment and detachment of the extension guide member 40 can be easily and immediately performed.
(12) In the stacking final process, the end plate 6 is placed by inserting the extension guide member 40 into the through-hole 62 provided in the end plate 6 on the upper side (FIG. 11D). The assembly method of the fuel cell stack 100 further includes a process (sealing process) of sealing the through-hole 62 after the extension guide member 40 is pulled out (FIG. 12). Therefore, it possible to prevent moisture or the like from entering from the outside through the through-hole 62.
(13) The assembly method of the fuel cell stack 100 further includes a process (preparation process) of manufacturing the guide member 10 by extrusion molding. As a result, the long guide member 10 can be accurately formed, and the guide member 10 can be easily inserted along the engagement groove 110 of the inner surface 103b of the case 103.

In the above-described embodiment, the recess 120 and the protrusion portion 121 served as a guide support portion are provided on the inner wall of the case 103 as the housing, that is, on the inner surface 103b. That is, in a case where a stacked direction of the cell stacked body 101 is defined as a first direction, a direction perpendicular to the stacked direction and the inner wall, i.e., a thickness direction of the inner wall (groove depth direction) is defined as a second direction, and a direction (groove width direction) perpendicular to the first direction and the second direction is defined as a third direction, the movement in the second direction and the movement in the third direction are restricted by the recess 120 and the protrusion portion 121. However, the configurations of a first restriction portion that restricts the movement of the guide member in the second direction and a second restriction portion that restricts the movement of the guide member in the third direction are not limited to those described above. In the above-described embodiment, the pair of engagement projection portions 13 and 13 are provided at the distal end portion of the guide member 10, and the pair of engagement recesses 36 and 36 are provided at the edge portion of the separator 3 corresponding to the engagement projection portions, but the configuration of a guide member is not limited to the above-described configuration, and therefore, the configuration of an engagement portion is not limited to the above-described configuration. For example, a recess and a protrusion portion may be provided at an edge portion of the separator 3, similar to the recess 120 on the inner surface 103b of the case 103 and the protrusion portion 121. In the above-described embodiment, one end portion of the guide member 10 in the longitudinal direction is fitted into the bottomed recess 61 of the end plate 6 so as to hold the guide member 10, but the configuration of an end support portion is not limited thereto.

The above embodiment can be combined as desired with one or more of the above modifications. The modifications can also be combined with one another.

According to the present invention, in a case where an impact is applied from an outside, it is possible to suppress a damage of a cell stacked body.

Above, while the present invention has been described with reference to the preferred embodiments thereof, it will be understood, by those skilled in the art, that various changes and modifications may be made thereto without departing from the scope of the appended claims.

What is claimed is:

1. A fuel cell stack comprising:
a cell stacked body configured to stack alternately a unitized electrode assembly having an electrolyte membrane and an electrode, and a separator;
a case surrounding the cell stacked body; and
a guide member attached to an inner wall of the case to extend in a stacked direction of the cell stacked body and including an engaged portion protruding toward an edge portion of the separator, wherein
the separator includes an engagement portion engaging with the engaged portion of the guide member,
the inner wall includes a guide support portion supporting the guide member,
the stacked direction is a first direction, a thickness direction of the inner wall perpendicular to the stacked direction is a second direction, and a direction perpendicular to the first direction and the second direction is a third direction, and
the guide support portion includes a first restriction portion restricting a movement of the guide member in the second direction and a second restriction portion restricting a movement of the guide member in the third direction.

2. The fuel cell stack according to claim 1, wherein
the guide support portion includes
a recess portion forming an engagement groove having a predetermined depth and extending along the stacked direction up to an end surface of the case in the stacked direction, and
a protrusion portion protruding toward an inside in a width direction of the engagement groove at an groove inlet portion on an inlet side of the engagement groove so that a width of the groove inlet portion is narrower than a width of a groove bottom portion on a bottom side of the engagement groove, and
the guide member includes
a base portion disposed in the groove inlet portion, and
a wide portion disposed in the groove bottom portion and enlarged from the base portion in the width direction.

3. The fuel cell stack according to claim 2, wherein
the protrusion portion is provided at a bulged portion bulged from the inner wall of the case toward the edge portion of the separator.

4. The fuel cell stack according to claim 2, wherein
the second direction is a depth direction of the engagement groove, and the third direction is the width direction of the engagement groove, and
a length of a gap from an end surface of the wide portion to an end surface of the protrusion portion facing each other in the second direction, and a length of a gap from an end surface of the base portion to an end surface of the protrusion portion facing each other in the second direction are shorter than a length of a gap from an end surface of the groove bottom portion to an end surface of the wide portion facing each other in the third direction.

5. The fuel cell stack according to claim 4, wherein
the guide member includes a first end portion and a second end portion in a longitudinal direction,
the fuel cell stack further comprises
an end plate including an end support portion supporting the first end portion of the guide member,
the guide member includes the base portion and the wide portion over an entire length of the guide member in the longitudinal direction,
the end support portion is configured by a bottomed recess into which the first end portion of the guide member is fitted, and
a length of a gap from the end surface of the base portion to an end surface of the bottomed recess facing each other in the third direction is shorter than the length of the gap from the end surface of the base portion to the end surface of the protrusion portion facing each other in the third direction.

6. The fuel cell stack according to claim 5, wherein
the bottomed recess has an arc shaped portion facing a corner of the engaged portion.

7. The fuel cell stack according to claim 5, wherein
the end plate is a first end plate including a first end support portion served as the end support portion, and
the fuel cell stack further comprises
a second end plate including a second end support portion supporting the second end portion of the guide member in the longitudinal direction.

8. The fuel cell stack according to claim 7, wherein
the second end support portion is configured by a through-hole, and
the fuel cell stack further comprises
a cover coving the through-hole.

9. The fuel cell stack according to claim 7, wherein
the first end plate is provided with supply and discharge through-holes to supply a reaction gas and a cooling medium to the cell stacked body and discharge the reaction gas and the cooling medium from the cell stacked body, while the second end plate is not provided with the supply and discharge through-holes.
